(19) United States
(12) Patent Application Publication
(10) Pub. No.: US 2013/0215234 A1
(43) Pub. Date: Aug. 22, 2013

(54) METHOD AND APPARATUS FOR STEREO MATCHING

(71) Applicants: Eul Gyoon LIM, Daejeon (KR); Dae Hwan HWANG, Daejeon (KR); Ho Chul SHIN, Daejeon (KR); Jae II CHO, Daejeon (KR)

(72) Inventors: Eul Gyoon LIM, Daejeon (KR); Dae Hwan HWANG, Daejeon (KR); Ho Chul SHIN, Daejeon (KR); Jae II CHO, Daejeon (KR)

(73) Assignee: ELECTRONICS AND TELECOMMUNICATIONS RESEARCH INSTITUTE, Daejeon (KR)

(21) Appl. No.: 13/615,137

(22) Filed: Sep. 13, 2012

(30) Foreign Application Priority Data
Feb. 16, 2012 (KR) 10-2012-0016026

(51) Int. Cl. H04N 13/02

(52) U.S. Cl. 348/47; 348/E13.074

(57) ABSTRACT

Disclosed is a stereo matching method for calculating disparity from binocular images. The stereo matching method extracting distance information of objects included in images by using binocular images, includes receiving the binocular images acquired from a first camera and a second camera for acquiring the binocular images; processing the images so as to increase contrast between objects and background objects included in the received images by using a predetermined first algorithm; and performing, stereo matching using the processed images. An exemplary embodiment of the present invention outputs a disparity map in which objects and background are divided, thereby robustly recognizing a person or obstacles.

### CROSS-REFERENCE TO RELATED APPLICATIONS

This application claims priority to and the benefit of Korean Patent Application No. 10-2012-0016026 filed in the Korean Intellectual Property Office on Feb. 16, 2012, the entire contents of which are incorporated herein by reference.

### TECHNICAL FIELD

The present invention relates to a configuration of a stereo matching system which calculates disparity using a dual camera.

### BACKGROUND ART

A technology of obtaining distance information from images using two cameras is generally referred to as a stereo matching technology.

A problem of a corresponding relation of finding points at which two images of the same scene are aggregated at the time of the stereo matching corresponds to the most important process in the time of calculating stereo.

Hereinafter, a principle thereof will be briefly described.

FIG. 1 is a diagram showing an example of a pin hole camera model for describing disparity in a general parallel-axis stereo camera.

As shown in FIG. 1, for example, in a point an a z-axis, an image is focused at an center of a sensor plane of a left camera, focused at a place spaced by d*w from the center of the sensor plane a right camera, and is focused at a place spaced by d pixel from the center of a right camera image. The d value is referred to as disparity and may be obtained by a cross point between two straight lines L1 and L2, which is a function of a focal distance f of two cameras, a distance B between two cameras, a pixel width w of a sensor, and a distance z from a pin hole of a camera to a subject. As such, when images are obtained using two cameras, one object exists at different positions in two images due to a difference in position between two cameras.

It is possible to obtain the distance information to objects in images by searching whether each pixel of one image is the most similar to a pixel of another image by using the above property and the searched results.

A stereo matching system of calculating disparity using images received from two cameras may be largely classified into local approach, global approach, semi-global approach, and the like. Among others, the semi-global approach performs one-dimensional energy optimization and therefore, can be implemented by hardware such as ASIC, and the like, and has been prevalently used.

In the semi-global approach, a stereo matching technology based on Viterbi algorithm determines an increase and decrease in a disparity value between neighboring pixels by using various types of lattice structures. A penalty of disparity discontinuity (PD) value is used during a process of determining the increase and decrease in the disparity value. The PD value means a kind of penalty value that prevents a path from one node to nodes having different level of disparity values from being selected as an optimal path.

The general PD value uses a fixed value for the entire screen. In this case, when a difference in objects and a background is small, a change in disparity may be suppressed by a relatively large PD value.

Next, two examples of a disparity map obtained by setting an absolute difference value of a gray scale image as raw cost and inputting the set cost to a lattice structure of [Document 1] will be described.

[Document 1] Hong JEONG and Yuns OH, “Fast Stereo Matching Using

Constraints in Discrete Space”, IEICE TRANS. INF. & SYST. VOL. E83-D, NO. 7 JULY 2000.

FIGS. 2A and 2B show that other portions of a person are shown in the disparity map, but shows a case in which a portion of an abdomen does not appear in FIG. 2A. and a case in which the surrounding of a person's mouth disappears in FIG. 2B.

As described above, dynamic programming type stereo matching is performed in scan line unit but when one PD value is used for the entire screen, a phenomenon of disconnection of objects on the disparity map due to the background may frequently occur. When this phenomenon occurs, it is very difficult to perform operations of separating a person or other obstacles using the disparity map. The related art has proposed a method of composing the disparity maps obtained by using different PD values, but cannot completely prevent the case in which the disconnection of objects locally occurs due to similar backgrounds.

### SUMMARY OF THE INVENTION

The present invention has been made in an effort to provide an apparatus and a method for reducing disconnection of objects on a disparity map that is a stereo matching result by preprocessing images input to dynamic programming type stereo matching.

An exemplary embodiment of the present invention provides a stereo matching method including: receiving, by a image input unit, the binocular images acquired from a first camera and a second camera for acquiring the binocular images; processing, by a image processing unit, the images so as to increase contrast between objects and background objects included in the received images by using a predetermined first algorithm; and performing, by a stereo matching unit, stereo matching using the processed images.

The processing of the images may include: extracting, by an average image extracting unit, average images having an average information value from the received images; extracting, by a reflectance component extracting unit, information on reflectance component representing features of the objects in the images by using the extracted average images; and compressing, by the reflectance component compressing unit, information on the extracted reflectance component.

The extracting of the average image may include: extracting, by an illumination component extracting unit, information on illumination component representing light and shade in the images by using a predetermined second algorithm; and convoluting, by a convolution unit, information on the extracted illumination component and information on the received images to extract the average images.

In the extracting of the information one the reflectance component, pixel information values of the extracted average images may be removed from pixel information values of the images according to coordinates of the pixels of the received images to extract the information on the reflectance component.

In the compressing of the information on the extracted reflectance component, the information on the reflectance component extracted in the extracting of the information on the reflectance component may be log-scaled.

The stereo matching method may further include: prior to processing the images, rectifying, a image rectifying unit, images so as to align scan lines that are a reference line at the time of performing the stereo matching of the received images, wherein in the processing, the images rectified in the performing of the rectification are processed.

In the performing of the stereo matching, the stereo matching of the images may be performed by using dynamic programming.

The stereo matching method may further include: prior to the performing of the stereo matching, calculating, by an cost aggregation unit, aggregated cost for the images processed in the processing, wherein in the performing of the stereo matching, the stereo matching is performed using the calculated aggregated cost.

The calculating of the aggregated cost may further include calculating, by the rectified cost aggregation unit, the rectified aggregated cost using the calculated aggreation cost and the received binocular images, wherein in the performing the stereo matching, the stereo matching is performed using the summed aggregated cost.

In the performing of the stereo matching, a disparity map may be generated by performing the stereo matching.

An exemplary embodiment of the present invention provides a stereo matching apparatus extracting distance information of objects included in images by using binocular images according to another exemplary embodiment of the present invention: including: a image input unit configured to receive the binocular images acquired from a first camera and a second camera for acquiring the binocular images; a image processing unit configured to increase contrast between objects and background objects included in the received images by using a predetermined first algorithm; and a image processing unit configured to perform stereo matching using the processed images.

The image processing unit may include: an average image extracting unit configured to extract average images having an average information value from the received images; a reflectance component extracting unit configured to extract information on reflectance component representing features of the objects in the images by using the extracted average images; and a reflectance component compressing unit configured to compress information on the extracted reflectance component.

The average image extracting unit may include: an illumination component extracting unit configured to extract information on illumination component representing light and shade in the images by using a predetermined second algorithm; and a convolution unit configured to convolute information on the extracted illumination component and information on the received images to extract the average images.

The reflectance component extracting unit may remove pixel information values of the extracted average images from pixel information values of the images according to coordinates of the pixels of the received images to extract the information on the reflectance component.

The reflectance component compressor may log-scale the information on the reflectance component extracted from a portion extracting the information on the reflectance component.

The stereo matching apparatus may further include: a image rectifying unit configured to align scan lines that are a reference line at the time of performing stereo matching of the processed image, wherein the stereo matching unit uses the images obtained by rectifying the processed images by the image rectifying unit or the image processing unit processes the images rectified by the image rectifying unit.

The stereo matching unit may perform the stereo matching of the images by using a dynamic programming type.

The stereo matching apparatus may further include: an cost aggregation unit configured to calculate aggregated cost for the images processed in the processing unit, wherein the stereo matching unit performs the stereo matching using the calculated aggregated cost.

The cost aggregation unit may further include a rectified cost aggregation unit configured to calculate the rectified aggregated cost by using the received binocular images, wherein the stereo matching unit uses the rectified aggregated cost to perform the stereo matching.

The stereo matching unit may perform the stereo matching to generate the disparity map.

According to the exemplary embodiments of the present invention, the stereo matching system outputs the disparity map in which the objects and the background are divided from each other by performing the stereo matching using the preprocessing of the images input to the dynamic programming type stereo matching even in the condition (condition in which the objects and the background are similar to each other) in which the existing stereo matching system outputs the disparity map in which the objects are disconnected, such that the system (intelligent mobile robot, or the like) used by the stereo matching system can robustly recognize the person or the obstacles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing an example of a pin hole camera model for describing disparity in a general parallel-axis stereo camera.

FIGS. 2A and 2B are diagrams showing examples of a phenomenon in which a portion of objects disappears in a disparity map.

FIG. 3 is a flow chart showing a stereo matching method according to the exemplary embodiment of the present invention.

FIG. 4 is a flow chart showing processing detailed images by a stereo matching method according to an exemplary embodiment of the present invention.

FIG. 5 is a flow chart showing extracting detailed average images by a stereo matching method according to an exemplary embodiment of the present invention.

FIG. 6 is a diagram showing an example of the images and profiles obtained by processing input original images by a first algorithm according to an exemplary embodiment of the present invention.

FIGS. 7A and 7B are flow charts showing an example including rectifying images by a stereo matching method according to an exemplary embodiment of the present invention.

FIG. 8 is a flow chart showing calculating detailed aggregated cost by a stereo matching method according to an exemplary embodiment of the present invention.

FIG. 9 is a diagram showing an example of a time difference map generated by the stereo matching method according to the exemplary embodiment of the present invention.

FIG. 10 is a block diagram showing a stereo matching apparatus according to an exemplary embodiment of the present invention.

FIG. 11 is a block diagram showing a detailed configuration of a image processing unit of a stereo matching apparatus according to an exemplary embodiment of the present invention.

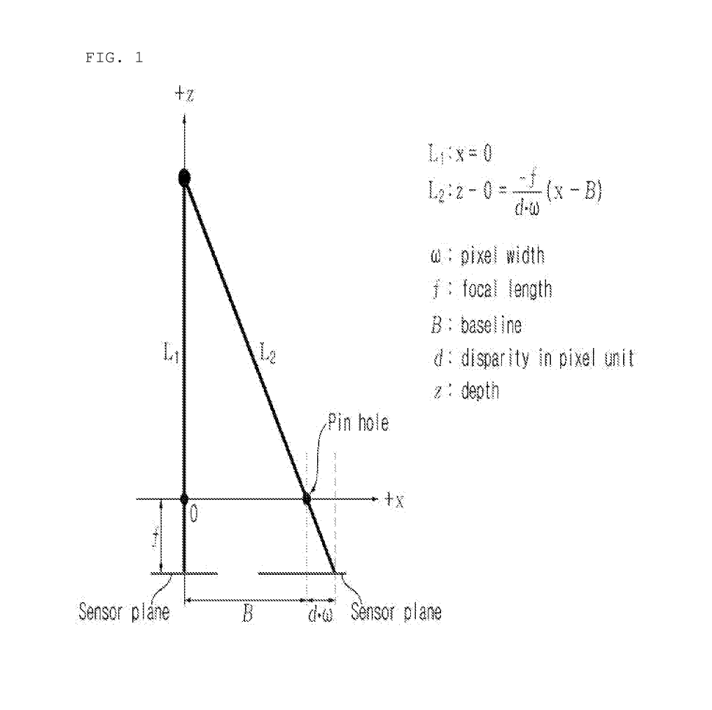

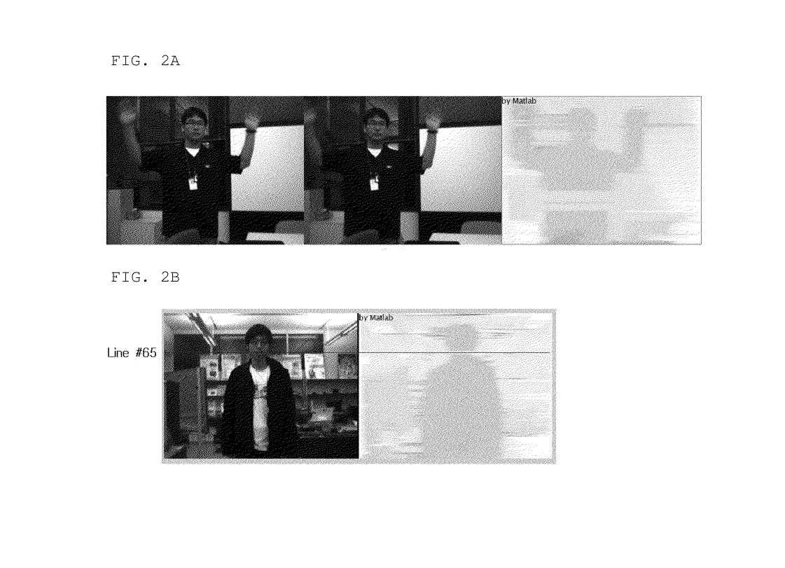

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

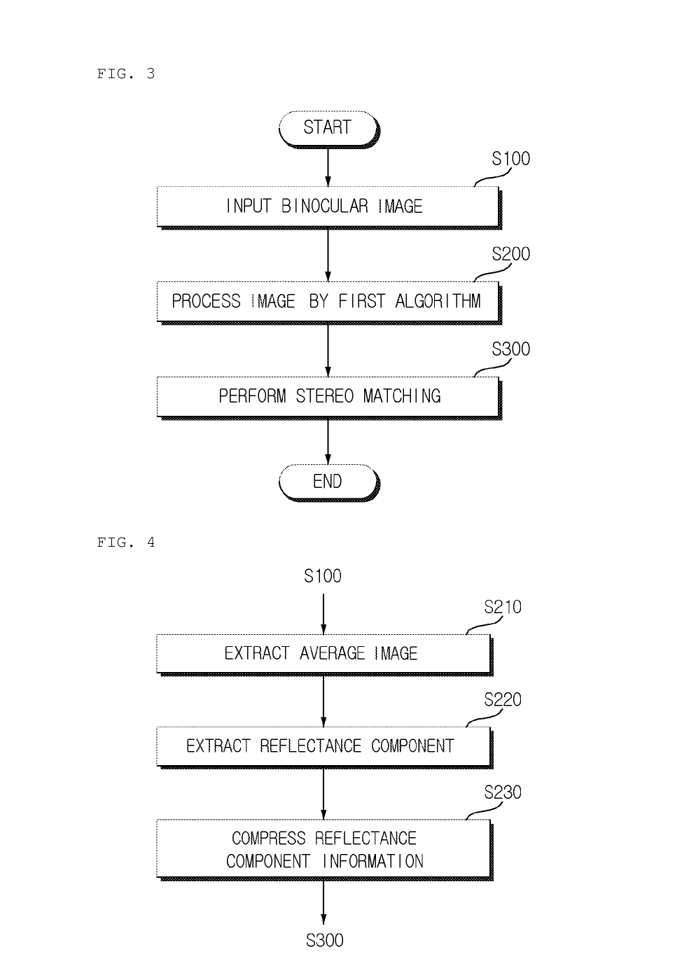

FIG. 3 is a flow chart showing a stereo matching method according to the exemplary embodiment of the present invention.

Referring to FIG. 3, the stereo matching method according to the exemplary embodiment of the present invention includes receiving binocular images (S100), processing images by a first algorithm (S200), and performing stereo matching (S300).

The binocular images means left and right images that are obtained by photographing objects by a left camera and objects by a right camera, according to a relative position thereof. The objects may be objects from which relative distance information is extracted by a disparity map obtained by performing the stereo matching.

In the receiving of the binocular images (S100), the image input unit 100 receives the binocular images obtained from a first camera and a second camera for obtaining the binocular images. The first camera and the second camera are referred to as the above-mentioned left or right cameras and an order thereof is independent of left and right positions.

In the processing of the images by the first algorithm (S200), the image processing unit 200 increases contrast between objects and background objects included in the received images by using the predetermined first algorithm.

The first algorithm may differentiate color information of each object by adapting a person's eye to environment over time, which may be an algorithm that increases contrast by adapting the person's eye to environment so that performance on the person's eye is represented even in the images. The first algorithm is a method that reduces an effect of illuminance component and indicates reflectance component representing features of objects by assuming a Weber-Fechner's law having a log relationship between brightness of the images and recognized sensation and a Land's visual model in which the brightness of the images are formed of a product of illuminance component and the reflectance component, thereby improving contrast.

A basic principle of the first algorithm may remove background component from the input images. The background images may be considered as average images of the input images, which may be obtained by applying a Gaussian filter. When applying the filter, a scale smaller than a filter size disregards in the input images. The reflectance component in the input images may be extracted by dividing the input images by the above-mentioned obtained background images.

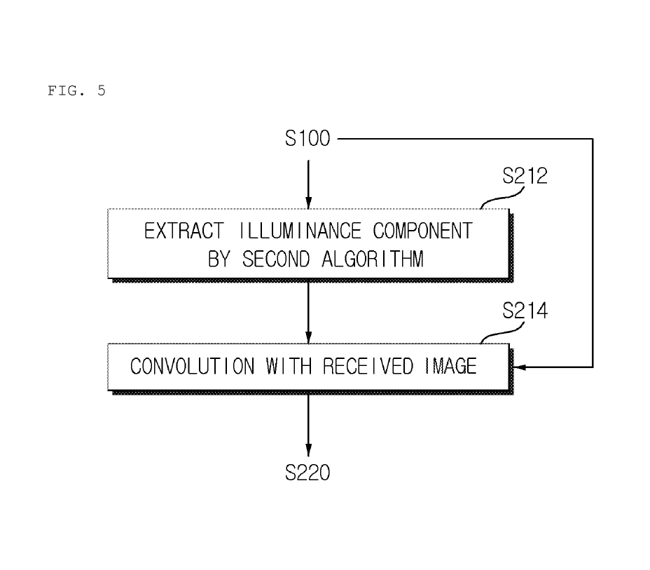

The processing of the images (S200) will be described in more detail with reference to FIGS. 4 and 5.

FIG. 4 is a flow chart showing the processing of the detailed images by a stereo matching method according to an exemplary embodiment of the present invention.

Referring to FIG. 4, the processing of the images (S200) includes extracting average images (S210), extracting reflectance component (S220), and compressing information on the extracted reflectance component (S230).

In the extracting of the average images (S210), an average image extracting unit 210 extracts the average images having an average information value from the received images in the receiving of the binocular images (S100). As described above, the average images may be background objects of the input images and the background information may be information having an average value for color, brightness, and the like, in the received images.

Referring to FIG. 5, the extracting of the average images (S210) includes extracting illuminance component (S212) by the second algorithm and convoluting the extracted illuminance component with the received images (S214).

In the extracting of the illuminance component by the second algorithm (S212), the illuminance component extracting unit 212 extracts the information on the illuminance component that represents light and shade in the images by using the predetermined second algorithm. The predetermined second algorithm may be a function for extracting the illuminance component from the received images. In the exemplary embodiment of the present invention, the second algorithm may be a Gaussian center/surround function. The Gaussian function is represented by Equation 1. x and y means coordinates x and y of a pixel in the received images and c means a constant of Gaussian function. c determines a reflection degree of a center value and neighboring values of the Gaussian function and when c is too small, information of a dark region is recovered while preserving a boundary of the images. However, a difference between a dark area and a bright area in original images is too reduced to obtain images that are seen by a gray tone. On the other hand, when c is large, a difference between a dark area and a bright region is appropriate but the boundary information of the images and the information of the bright area are lost.

F(x,y)=Kexp[−(x²+y²)/c²] [Equation 1]

In Equation 1, K is obtained by Equation 2.

∫∫F(x,y)dxdy=1 [Equation 2]

In the convoluting of the received images (S214), the convolution unit 214 extracts the average images by convoluting the information on the illuminance component extracted in the extracting of the illuminance component (S212) and the information of the received images.

In the exemplary embodiment of the present invention, the convolution is represented by the following Equation 3. (x, y) means a coordinate of the corresponding pixel and Iᵢ(x,y) represents i-th color component. That is, in the case of the RGB image, i=1, 2, 3. *operation represents convolution operation.

F(x,y)*Iᵢ(x,y) [Equation 3]

The extracting of the reflectance component (S220) extracts the information on the reflectance component that represents features of the objects in the images by using the average images extracted by the reflectance component extracting unit 220. As described above, the reflectance component is to reduce the effect of illuminance component and extract the components representing the features of objects from the received image by assuming the Weber-Fechner's law having the log relationship between the brightness of images and the recognized sensation and the Land's visual model in which the brightness of images is formed of a product of illuminance component and the reflection component.

According to the exemplar embodiment of the present invention, in the extracting of the reflectance component (S220), the reflectance component extracting unit 220 may remove the pixel information values of the extracted average images from the pixel information values of the images according to the coordinates of the pixels of the received images to extract the information on the reflectance component.

The extraction of the reflectance component may be made by dividing the reflectance component in the input images by the average images (background images) extracted in the extracting of the average images (S210). This may be represented by Equation 4.

Iᵢ(x,y)/(F(x,y)*Iᵢ(x,y)) [Equation 4]

In the compressing of the information of the reflectance component (S230), the reflectance component compressing unit 230 compresses the information on the reflectance component extracted in the extracting of the reflectance component (S220). Compressing the information of the reflectance component may correspond to compressing the range in which the reflectance component is distributed.

In the exemplary embodiment of the present invention, in the compressing of the information of the reflectance component (S230), it is preferable to perform log scale on the information on the reflectance component extracted in the extracting of the information on the reflectance component (S220). The image information processed (S300) in the compressing of the information of the reflectance component (S230) according to the exemplary embodiment of the present invention is represented by Equation 5.

Rᵢ(x,y)Rᵢ(x,y) represents results processed by compressing a (x, y) pixel of the received image for an i-th color.

Rᵢ(x,y)=log Iᵢ(x,y)−log[F(x,y)*Iᵢ(x,y)] [Equation 5]

Since the pixel value is converted into the log scale, aggregated cost is calculated using the converted log scale to suppress the excessive difference between two pixels from being reflected to the aggregated cost. When the stereo matching is performed on the images performing the processing of the images (S200) according to the exemplary embodiment of the present invention, the difference between the objects and the background is emphasized and thus, the disconnection of the objects can be improved.

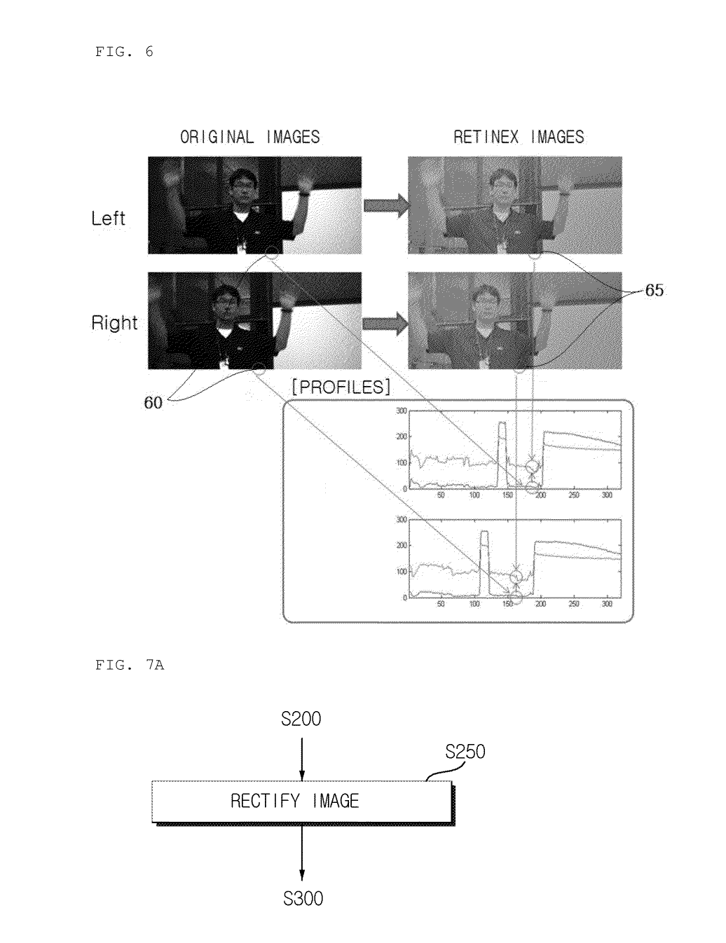

FIG. 6 is a diagram showing an example of images and profiles obtained by processing input original images by a first algorithm according to an exemplary embodiment of the present invention.

Referring to FIG. 6, when the right boundary of the objects is located in the background of similar colors and thus, the disconnection occurs on the disparity map (60), the boundary is effectively emphasized at the original images by applying the exemplar embodiment of the present invention and as a result, it can be appreciated that the disconnection problem of the objects on the disparity map is improved (65).

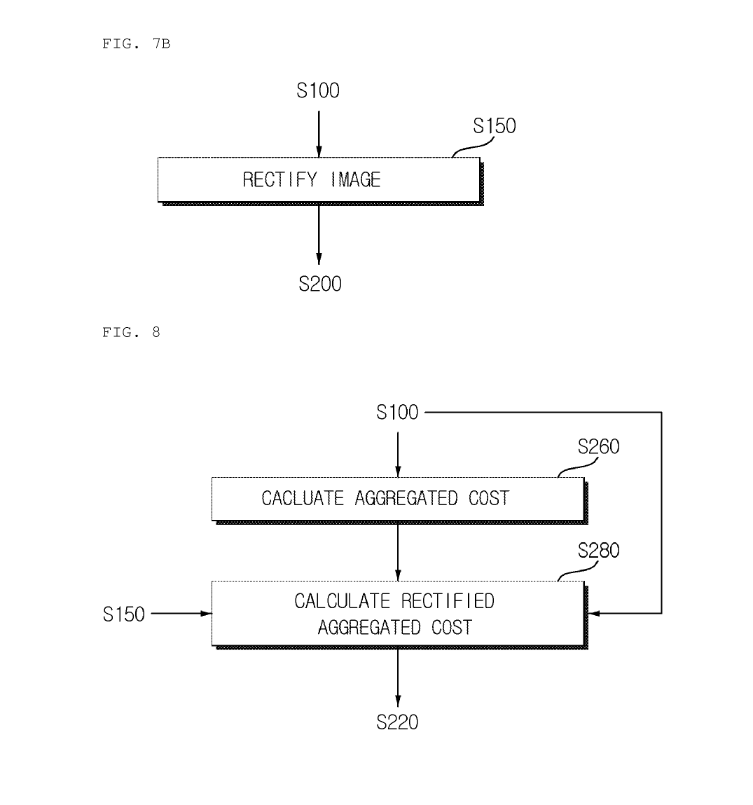

Referring to FIG. 7A, the stereo matching method according to the exemplary embodiment of the present invention may include rectifying images (S250) that align the scan lines, prior to the performing of the stereo matching (S300).

In the rectifying of the images (S250), a image rectifying unit 400 aligns the scan lines that are a reference line at the time of performing the stereo matching. According to the exemplary embodiment of the present invention, in the rectifying of the images (S250), the binocular images, that is, the left image and the right image are aligned and the image rectification is performed so as to align the scan lines of the left image and the right image. In this case, it is preferable to perform the image rectification by using preset parameters according to the mismatched degree.

In addition, prior to the processing of the images (S200) as shown in FIG. 7B, in the rectifying of the images (S150), the image rectification unit 400 rectifies the scan lines of the received images. Herein, the processing of the images (S200) may be the processing of the rectified images.

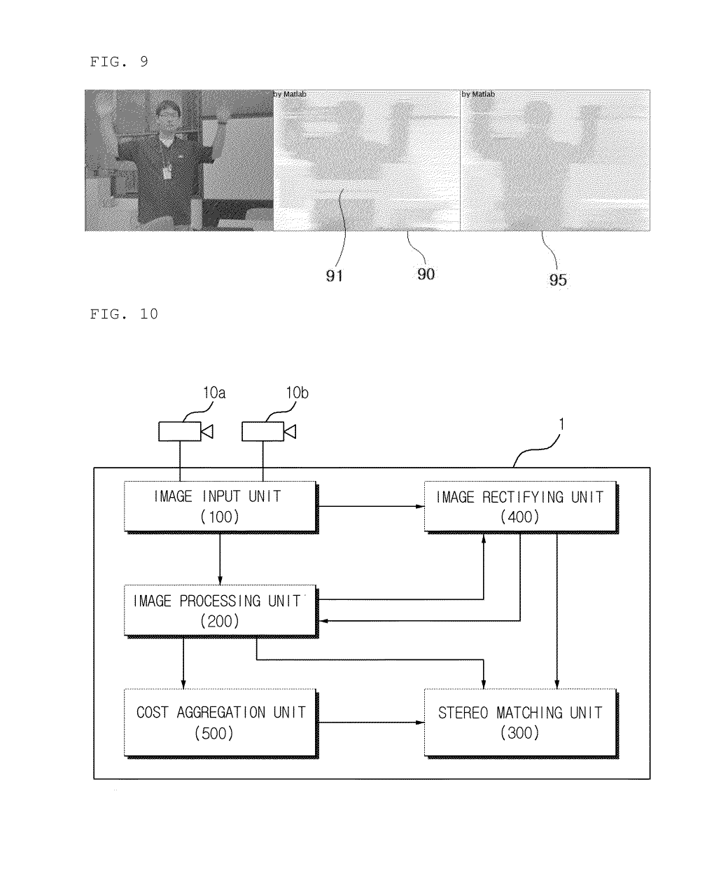

As shown in FIGS. 7B and 8, the stereo matching method according to the exemplary embodiment of the present invention may include calculating the aggregated cost (S260) prior to the performing of the stereo matching (S300).

In the calculating of the aggregated cost (S260), a cost aggregation unit 500 calculates the aggregated cost for images processed in the processing and in the performing of the stereo matching (S300), it is preferable to perform the stereo matching using the calculated aggregated cost.

The calculating of the aggregated cost corresponds to calculating similarity between pixels so as to find out a corresponding portion in the left image and the right image, and there are several methods for calculating the aggregated cost. In the calculating of the aggregated cost (S260), the aggregated cost calculated by any one of the methods may be aggregated using a support weight of a window having a predetermined size.

In addition, a preferred aggregated cost calculating method reflects a slight difference that can be observed by a persons' eye as a value and limits a value representing an excessive difference. In the exemplary embodiment of the present invention, the aggregated cost can be calculated by a method for improving an absolute difference (AD). A truncated AD method is a method that does not reflect the difference in the aggregated cost since the case in which the difference between two pixel values slightly exceeds a threshold hinders the stereo matching.

In addition, the stereo matching method according to the exemplary embodiment of the present invention may further include calculating the rectified aggregated cost (S280) prior to the performing of the stereo matching (S300).

In the calculating of the rectified aggregated cost (S280), the cost aggregation unit 500 may calculate the rectified aggregated cost using the binocular images receiving the aggregated cost calculated in the calculating of the aggregated cost (S260).

In the calculating of the rectified aggregated cost according to the exemplary embodiment of the present invention (S280), when the stereo matching is performed according to the cost calculated in the calculating of the aggregated cost (S260) by the cost aggregation unit 500, the calculated aggregated cost may again be trimmed in the original images by using the cost of the neighboring pixels so as to reduce the generated image distortion phenomenon.

In the performing of the stereo matching (S300), the stereo matching unit 300 performs the stereo matching using the processed images.

According to the exemplary embodiment of the present invention, the processed images used in the performing of the stereo matching (S300) may be the images rectifying (S250) the images processed in the processing (S200) or the images processed (S200) by rectifying the received images in the rectifying of the images (S150).

Alternatively, it is preferable to perform the stereo matching using calculating the aggregated cost for the processed images and using the aggregated cost rectified by using the calculated aggregated cost or the binocular images receiving the calculated aggregated cost.

In the performing of the stereo matching (S300), it is preferable to perform the stereo matching of the images by using the dynamic programming. The dynamic program type splits the overall results to derive the optimal results and generates the final results by combining the derived results. In the exemplary embodiment of the present invention, the sensitivity is dynamically controlled by performing the stereo matching on the processed images using the processing of the images (S200) to perform the stereo matching.

In the performing of the stereo matching (S300), it is preferable to generate the disparity map by performing the stereo matching. The disparity map generated in the exemplary embodiment of the present invention will be described with reference to FIG. 9.

FIG. 9 is a diagram showing an example of a disparity map generated by the stereo matching method according to the exemplary embodiment of the present invention.

As shown in FIG. 9, it can be appreciated that disconnection 91 is generated at the abdomen portion of the objects in the disparity map 90 generated by performing the stereo matching without performing the processing of the images (S200) but disconnection does not occur at a disparity map 95 generated according to the exemplary embodiment of the present invention.

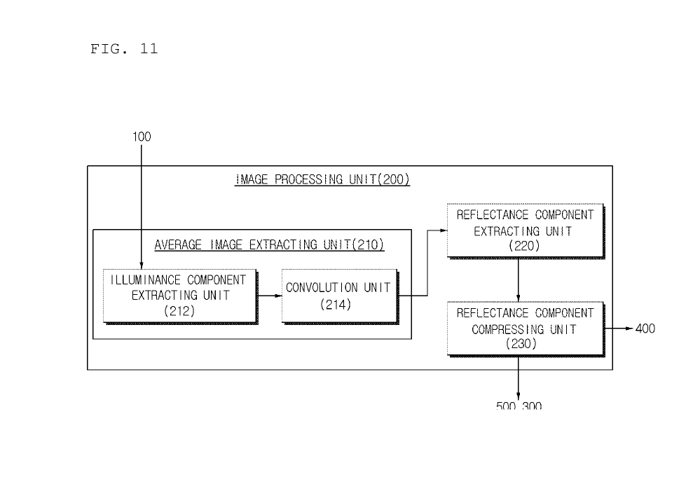

FIG. 10 is a block diagram showing a stereo matching apparatus according to an exemplary embodiment of the present invention.

As shown in FIG. 10, the stereo matching apparatus according to the exemplary embodiment of the present invention includes a first camera 10a, a second camera 10b, a image input unit 100, a image processing unit 200, a stereo matching unit 300, a image rectifying unit 400, and a matching cost calculating unit 500. The stereo matching apparatus 1 may be an apparatus for performing the above-mentioned stereo matching method.

The first and second cameras 10a and 10b are a image apparatus for acquiring the binocular images and the first and second cameras are referred to as the left or right cameras and the order thereof is independent of the left and right positions.

The image input unit 100 receives the binocular images acquired from the first camera 10a and the second camera 10b for acquiring the binocular images (S100).

The image processing unit 200 increases the contrast between the objects and the background objects included in the received images by using the predetermined first algorithm (S200). The image processing unit 200 may process the images input from the image input unit 100 or process the images rectified by the image rectifying unit 400 The image processing unit 200 will be described in detail with reference to FIG. 11.

As shown in FIG. 11, the image processing unit 200 includes an average image extracting unit 210, a reflectance component extracting unit 220, and a reflectance component compressing unit 230 and the average image extracting unit 210 includes an illumination component extracting unit 212 and a convolution unit 214.

The average image extracting unit 210 extracts the images received in the binocular image input unit 100 or the average images having the average information value in the images rectified by the image rectifying unit 400 (S210). The average image extracting unit 210 includes the illumination component extracting unit 212 and the convolution unit 214. The illumination component extracting unit 212 extracts the information on the illumination component that represents light and shade in the images by using the predetermined second algorithm (S212). The predetermined second algorithm may be a function for extracting the illuminance component from the received images.

The convolution unit 214 convolutes the information on the illumination information extracted from the illumination component extracting unit 212 and the information of the received images to extract the average images (S214).

The reflectance component extracting unit 220 extracts the information on the reflectance component that represents features of the objects in the images by using the extracted average images (S220).

The reflectance component compressing unit 230 compresses the information on the reflectance component extracted from the reflectance component extracting unit 220 (S230). Compressing the information of the reflectance component may correspond to compressing the range in which the reflectance component is distributed.

In the exemplary embodiment of the present invention, the reflectance component compressing unit 230 preferably log-scales the information on the reflectance component extracted from the reflectance component extracting unit 220.

The image rectifying unit 400 aligns the scan lines that are the reference line at the time of performing the stereo matching (S250). The rectification of the images according to the exemplary embodiment of the present invention may rectify the images received from the image input unit 100 or rectify the images obtained by processing the images input from the image processing unit.

The cost aggregation unit 500 calculates the aggregated cost for the images processed by the image processing unit 200 (S220) and the stereo matching unit 300 uses the calculated aggregated cost to perform the stereo matching (S300).

In addition, the cost aggregation unit 500 according to the exemplary embodiment of the present invention may calculate the rectified aggregated cost (S240). The rectified aggregated matching cost may use the binocular images receiving the aggregated cost calculated in the calculating of the aggregated cost (S200) to calculate the rectified aggregated cost.

The stereo matching unit 300 performs the stereo matching by using the processed images (S300). In the exemplary embodiment of the present invention, the processed images used by the stereo matching unit 300 may be the images obtained by rectifying (S250) the images processed by the image processing unit 200 by the image rectifying unit 400 or the images processed (S200) by rectifying (S150) the received images by the image rectifying unit 400.

Alternatively, the cost aggregation unit 500 calculates the aggregated cost for the processed images and preferably performs the stereo matching using the aggregated cost (S280) rectified by using the calculated aggregated cost (S260) or the binocular images receiving the calculated aggregated cost.

In the performing of the stereo matching (S300), it is preferable to generate the disparity map by performing the stereo matching.

Meanwhile, the stereo matching method according to the exemplary embodiment of the present invention can be implemented by codes readable by a computer in a computer readable recording medium The computer readable recording media include all the types of recording apparatuses in which data readable by a computer system are stored.

The exemplary embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A stereo matching method extracting distance information of objects included in images by using binocular images, comprising:
receiving, by a image input unit, the binocular images acquired from a first camera and a second camera for acquiring the binocular images;
processing, by a image processing unit, the images so as to increase contrast between objects and background objects included in the received images by using a predetermined first algorithm; and
performing, by a stereo matching unit, stereo matching using the processed images.

2. The stereo matching method of claim 1, wherein the processing of the images includes:
extracting, by an average image extracting unit, average images having an average information value from the received images;
extracting, by a reflectance component extracting unit, information on reflectance component representing features of the objects in the images by using the extracted average images; and
compressing, by the reflectance component compressing unit, information on the extracted reflectance component.

3. The stereo matching method of claim 2, wherein the extracting of the average image includes:
extracting, by an illumination component extracting unit, information on illumination component representing light and shade in the images by using a predetermined second algorithm; and
convoluting, by a convolution unit, information on the extracted illumination component and information on the received images to extract the average images.

4. The stereo matching method of claim 2, wherein in the extracting of the information on the reflectance component, pixel information values of the extracted average images are removed from pixel information values of the images according to coordinates of the pixels of the received images to extract the information on the reflectance component.

5. The stereo matching method of claim 2, wherein in the compressing of the information on the extracted reflectance component, the information on the reflectance component extracted in the extracting of the information on the reflectance component is log-scaled.

6. The stereo matching method of claim 1, further comprising: prior to the performing of the stereo matching,
rectifying, a image rectifying unit, images so as to align scan lines that are a reference line at the time of performing the stereo matching of the processed images,
wherein in the performing of the stereo matching, images obtained by rectifying the processed images in the rectifying of the images are used.

7. The stereo matching method of claim 1, further comprising: prior to processing the images,
rectifying, a image rectifying unit, images so as to align scan lines that are a reference line at the time of performing the stereo matching of the received images,
wherein in the processing, the images rectified in the performing of the rectification are processed.

8. The stereo matching method of claim 1, wherein in the performing of the stereo matching, the stereo matching of the images is performed by using dynamic programming.

9. The stereo matching method of claim 7, further comprising: prior to the performing of the stereo matching,
calculating, by an cost aggregation unit, aggregated cost for the images processed in the processing,
wherein in the performing of the stereo matching, the stereo matching is performed using the calculated aggregated cost.

10. The stereo matching method of claim 9, wherein the calculating of the aggregated cost further includes calculating, by the rectified cost aggregation unit, the rectified aggregated cost using the calculated aggregated cost and the received binocular images,
wherein in the performing the stereo matching, the stereo matching is performed using the summed aggregated cost.

11. The stereo matching method of claim 1, wherein in the performing of the stereo matching, a disparity map is generated by performing the stereo matching.

12. A stereo matching apparatus extracting distance information of objects included in images by using binocular images, comprising:
a vide input unit configured to receive the binocular images acquired from a first camera and a second camera for acquiring the binocular images;
a image processing unit configured to increase contrast between objects and background objects included in the received images by using a predetermined first algorithm; and
a image processing unit configured to perform stereo matching using the processed images.

13. The stereo matching apparatus of claim 12, wherein the image processing unit includes:
an average image extracting unit configured to extract average images having an average information value from the received images;
a reflectance component extracting unit configured to extract information on reflectance component representing features of the objects in the images by using the extracted average images; and
a reflectance component compressing unit configured to compress information on the extracted reflectance component.

14. The stereo matching apparatus of claim 13, wherein the average image extracting unit includes:
an illumination component extracting unit configured to extract information on illumination component representing light and shade in the images by using a predetermined second algorithm; and
a convolution unit configured to convolute information on the extracted illumination component and information on the received images to extract the average images.

15. The stereo matching apparatus of claim 13, wherein the reflectance component extracting unit removes pixel information values of the extracted average images from pixel information values of the images according to coordinates of the pixels of the received images to extract the information on the reflectance component.

16. The stereo matching apparatus of claim 13, wherein the reflectance component compressor log-scales the information on the reflectance component extracted from a portion extracting the information on the reflectance component.

17. The stereo matching apparatus of claim 12, further comprising:
a image rectifying unit configured to align scan lines that are a reference line at the time of performing stereo matching of the processed image,
wherein the stereo matching unit uses the images obtained by rectifying the processed images by the image rectifying unit or the image processing unit processes the images rectified by the image rectifying unit.

18. The stereo matching apparatus of claim 12, wherein the stereo matching unit performs the stereo matching of the images by using a dynamic programming type.

19. The stereo matching apparatus of claim 17, further comprising:
an cost aggregation unit configured to calculate aggregated cost for the images processed in the processing unit,
wherein the stereo matching unit performs the stereo matching using the calculated aggregated cost.

20. The stereo matching apparatus of claim 19, wherein the cost aggregation unit further includes a rectified cost aggregation unit configured to calculate the rectified aggregated cost by using the received binocular images, wherein the stereo matching unit uses the rectified aggregated cost to perform the stereo matching.
